(19) United States
(12) Patent Application Publication
(10) Pub. No.: US 2002/0179752 A1
(43) Pub. Date: Dec. 5, 2002

(54) Fiber recovery system

(75) Inventor: Mark W. Spencer, Oshkosh, WI (US)

Correspondence Address: RYAN KROMHOLZ & MANION, S.C., POST OFFICE BOX 26618, MILWAUKEE, WI, 53226, US

(73) Assignee: Fiber Recycling Technologies, Inc.

(21) Appl. No.: 09/870,396

(22) Filed: May 30, 2001

(51) Int. Cl. B02C 23/36

(52) U.S. Cl. 241/21; 241/46.17

(57) ABSTRACT

A system for recovering paper fiber from paper furnish material including at least one conveyor, a debaler, a weighbelt conveyor, a pulper and a double drum screen washer.

### BACKGROUND OF THE INVENTION

The present invention relates to a method of recycling and specifically to a method and system for recovery of paper fiber. Present systems for recovery of paper fiber require high energy and resources for production. The present system and method requires far less energy and resources, as it is far more efficient. This high efficiency lowers the overall cost of paper fiber recovery.

### SUMMARY OF THE INVENTION

Operation and components of the system begin with an infeed belt-type conveyor, which preferably includes cleats or sidewalls to propel and retain the material, in either baled or loose form, as it is conveyed to a debaler. The debaler may be of any known type, such as that disclosed in Cheesman et al., U.S. Pat. No. 5,556,041. The debaler breaks up the bulky furnish material into a metered stream of material having a lower density. The term “furnish” as used in paper manufacturing refers collectively to the ingredients furnished to the pulper for making pulp. Alternatively, if the material to be supplied to the infeed conveyor is in baled form, baling wires may be removed either prior to debating on the infeed conveyor, or processed through the debaler which snaps the wires and discharges them along with the material. Alternatively, a second conveyor, similar to the infeed conveyor may elevate the material to a dewiring device. The dewiring device removes the baling wires and other ferrous tramp metals from the furnish material.

After debating, the furnish material is dropped onto a transfer conveyor that re-elevates the furnish material to a weighbelt or other sliderbed style conveyor mounted on load cells. The load cells determine material weight per length of the conveyor over a set time span. The weighbelt determines how much material by weight is transported, thus giving the calculated pounds-per-minute rate of the transporting furnish material. Using this information, conveyor speeds may be varied to reach desired material per minute rates.

The furnish material is then fed from the weighbelt into a defibering or pulper unit such as those illustrated in Spencer et al., U.S. Pat. No. 5,593,098 and Spencer et al., U.S. Pat. No. 5,645,229, and a predetermined amount of water is introduced into the pulping device. The predetermined water amount is based on a ratio of water to furnish material, as determined using the material-per-minute amounts calculated by the weighbelt processor. The material-per-minute amount is relayed to a system controller, which adjusts the rate of incoming water accordingly. The water and furnish material mixture is repeatedly lifted and dropped by pulper internal lifting arms. The pulping process breaks down the furnish material into a saturated fiber slurry of approximately 10% consistency, and an amount of reject material such as dirt, plastic, non-ferrous metals and wood. The slurry is then retained in the pulper for a predetermined amount of time prior to being discharged from the pulper and sluice fed into a novel, low rpm, low horsepower rotating double drum screen.

The double drum screen of the present invention represents an improvement having particular application to recovery of pulp fiber from furnish material. An example of a prior art double drum screening apparatus may be seen in Zittel, U.S. Pat. No. 5,433,849. The present apparatus includes inner and outer screens rotating about a common central axis and supported by a frame assembly. Similarly to the Zittel reference, both drum screens are constructed of axially extending wedge wires held in position by circumferential exterior bands. The inner drum screen provides slot openings of a larger size than the wedge-wire of the outer drum screen. The size differential between openings in the inner and outer screens allows defibered paper to wash through the inner screen into the outer screen, while larger rejects are retained in the inner screen to be conveyed by inner flighting to a rejects discharge stream. The inner screen may be further fitted with a shower manifold having conventional nozzles to spray fluid onto fiber in the inner screen. It is to be understood that the term “fluid” as used herein, shall be defined as a gas including air, a liquid, a substance which flows, or a substance which differs from a solid in that it can offer no permanent resistance to change of shape. It shall further include mixtures of gases, mixtures of liquids, and mixtures of gas and liquids. If water is used to spray the fiber, the fiber is then diluted sufficiently to allow passage to the outer screen. The outer screen slot openings are small enough that the paper fibers in the slurry are retained in the outer screen, since there is no pressure on the screen or the slurry to force the fibers through the slots. As the slurry is carried on flighting in the outer screen, it tumbles, causing the inherent water in the slurry to drain through the slots. This process thickens the slurry to a 3-6% consistency. The inner flighting of the outer screen conveys the thickened slurry to an accepts discharge stream for further processing.

The present system provides a unique and efficient system for fiber recovery. Additionally, preliminary cleaning of the fiber-containing slurry is provided as inherent water present in the slurry is drained in the outer screen of the rotating drum component, carrying unwanted ash, unusable fibers, and ink particles with it to a rejects discharge stream. This added benefit reduces equipment required in downstream procedures to remove these smaller, unwanted components from the slurry.

### DESCRIPTION OF THE DRAWINGS

FIG. 1 is a schematic diagram showing the components used in the disclosed system.

FIG. 2 is a schematic diagram showing an alternative arrangement of the disclosed system.

FIG. 3 is a perspective view of the novel, double drum screen used in the present system.

FIG. 4 is an end view of the double drum screen shown in FIG. 3 and illustrating the inner and outer screen baskets.

FIG. 5 is an enlarged end view of the inner screen basket seen in FIG. 4.

FIG. 5a is an enlarged, fragmentary sectional view of the preferred wedge-wire configuration of the screens used in the double drum screen washer shown in the views of FIGS. 3 and 4.

FIG. 5b is a diagramatic view of two nozzle spray configurations namely a fan-like spray and a cone-like spray.

FIG. 6 is a perspective view of the inner screen basket seen in FIGS. 4 and 5.

FIG. 7 is a perspective view of the outer screen basket seen in FIG. 4.

FIG. 8 is a side elevational view, partially in phantom of the double drum screen seen in FIGS. 3 7, inclusive showing the relative lengths of the inner and outer screens and shower manifold.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

The present invention discloses a system and method of pulping paper furnish material for fiber recovery and includes a novel double drum screening apparatus.

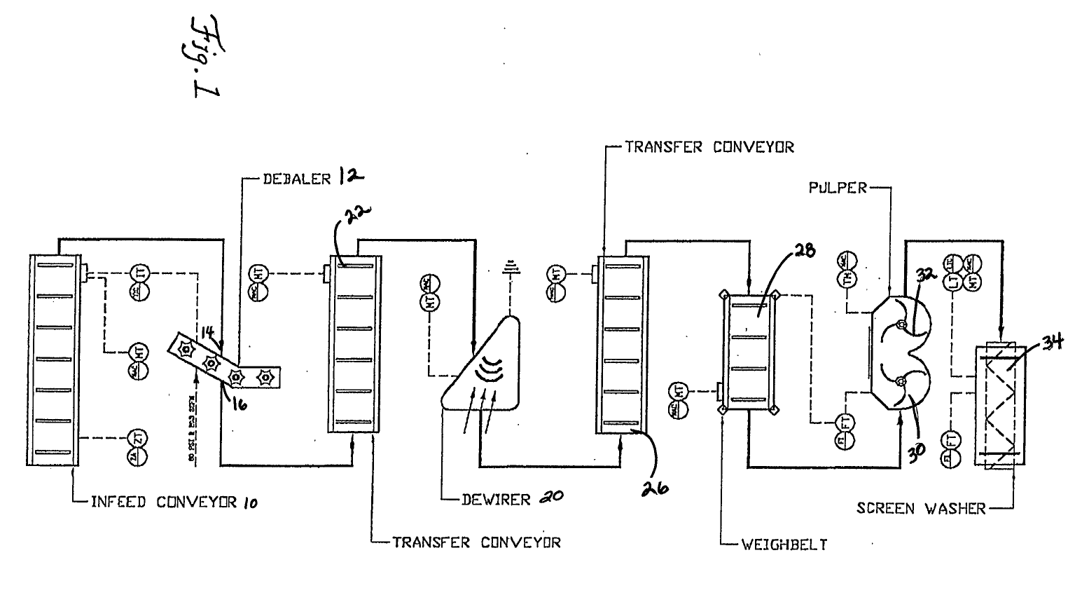

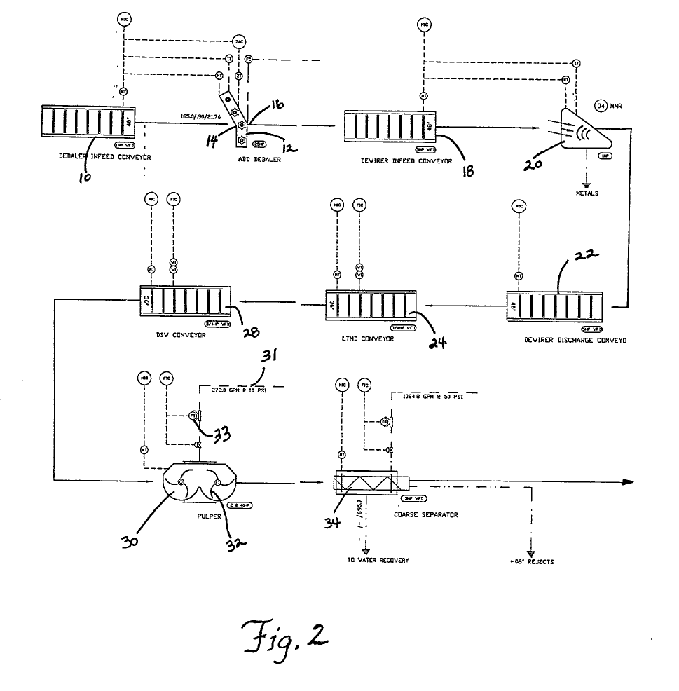

As seen particularly in the views of FIGS. 1 and 2, an infeed conveyor 10 receives furnish material (not shown) from which fiber is to be recovered. The furnish material may be presented to the infeed conveyor 10 in either loose or baled form. The infeed conveyor 10 preferably and conventionally includes cleats or sidewalls (not shown) to propel and retain the material as it is conveyed. While cleats and sidewalls are preferred, it is within the scope of this invention to include infeed conveyors 10 having any number of propulsion or retention features.

The infeed conveyor 10 transports the furnish material to a receiving apparatus 12. The receiving apparatus 12 may be a baled material disintegrator, or debaler, or pull-apart apparatus, or any other apparatus capable of breaking up the furnish material into a lower density stream. The receiving apparatus 12 includes an inlet 14 for receiving the furnish material from the infeed conveyor 10, and an outlet 16 for discharging the broken up material stream.

The receiving apparatus 12 may optionally include conventional means for snapping or severing baling wire (not shown) from furnish material received in baled form. The wires are then discharged along with the material stream for removal downstream. Alternatively, and as seen in FIG. 2, the furnish material may be transported by a dewirer infeed conveyor 18 to a dewiring apparatus 20. The material is then transported by a dewirer discharge conveyor 22 to a large tramp metal detection conveyor 24 for removal of any remaining baling wires and other ferrous and nonferrous tramp metals from the furnish material. Alternatively, a low volume, high pressure compressed air knife (not shown) may be used to separate the paper furnish from any remaining baling wires, ferrous and nonferrous tramp metal and other contaminants having a density higher than the furnish material. The furnish material is then returned to the material stream as lower density furnish.

With reference to FIG. 1, lower density furnish is dropped onto a transfer conveyor 26 that re-elevates and transports the material to a weighbelt, digital scale weigh conveyor, or other sliderbed style conveyor 28 mounted on load cells. The load cells (not shown) measure the furnish weight per length of the weighbelt 28 over time thereby determining the pounds-per-minute rate of the transporting furnish material.

As may be further seen in FIGS. 1 and 2, the weighbelt 28 then feeds the furnish material into a defibering or pulper unit 30. The pulper unit 30 is provided with a water inlet 31 to allow a predetermined amount of water to be introduced into the unit 30. The predetermined water amount is based on a ratio of water to furnish material, as determined using the material-per-minute amounts calculated by the weighbelt 28 processor. The material-per-minute amount is relayed to a system controller 33, which adjusts the rate of incoming water accordingly.

The water and furnish material mixture is repeatedly lifted and dropped by pulper internal lifting arms 32. The pulping process breaks down the furnish material into a saturated fiber slurry of approximately 10% consistency, and an amount of reject material such as dirt, plastic, non-ferrous metals and wood. The slurry is then retained in the pulper 30 for a predetermined amount of time prior to being discharged from the pulper 30 and sluice fed into a novel, low rpm, low horsepower rotating double drum screen washer 34.

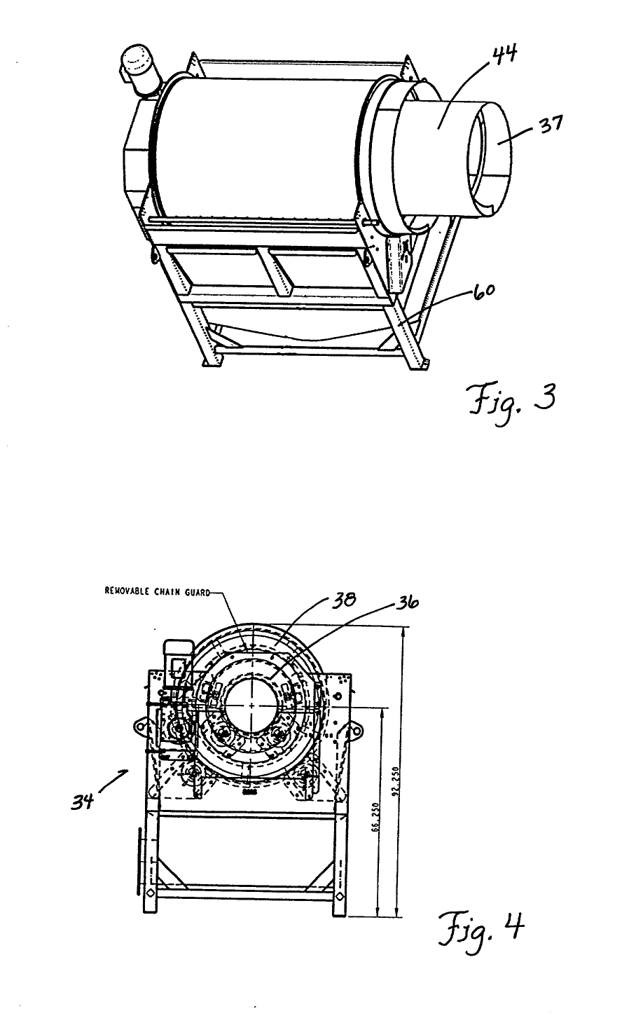

The double drum screen washer 34, seen in FIGS. 3-8, inclusive, and used in the present system allows defibered paper slurry to be screened to remove contaminants over a size of 0.06 inch. The double drum screen washer 34 includes an inner screen 36 and an outer screen 38. The screens 36, 38 each include a discharge end 37a, 37b, respectively. The inner screen 36 includes a wedge-wire design that allows for slot openings 39 of between 0.06 and 0.25 inch, thus allowing defibered paper to be washed through the inner screen 36 into the outer screen 38. The outer screen 38 also preferably utilizes a wedge-wire design.

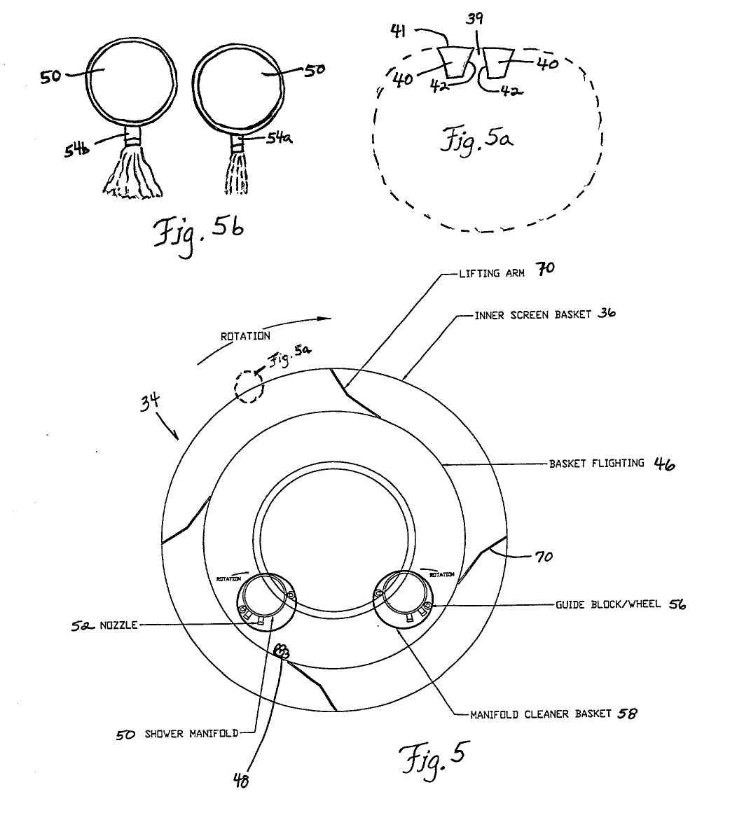

Wedge wire 40, as seen in cross section in FIG. 5a, resembles a wedge or truncated triangle. The bases 41 of the triangles form the filtering surface. This configuration is preferred for the material used for screens 36, 38, since material passing through the screen(s) 36, 38 experiences increasing clearance between adjacent sides 42 of the wedge wires 40, thus allowing free movement through the screen(s) 36, 38.

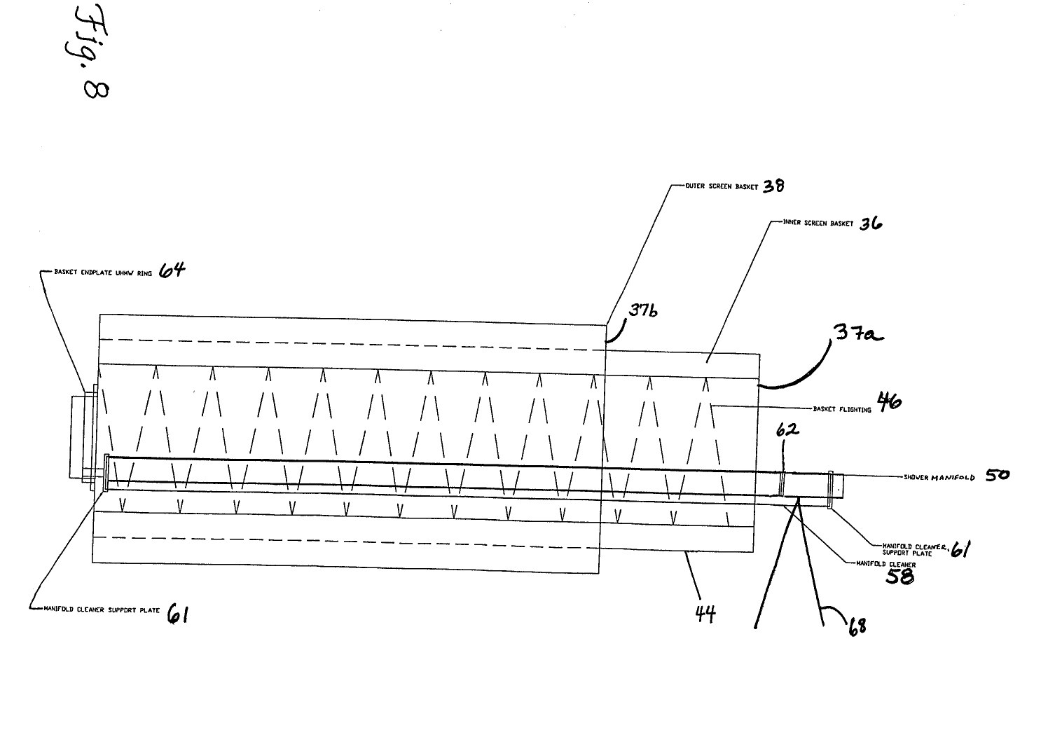

The outer screen 38 may also include slot openings 39 of between 0.06 and 0.01 inch. It has been observed that 0.01-inch slots are small enough to prevent the paper fiber from passing through since there is no pressure in the outer screen 38 or on the material to thereby force the fiber through the slots 39. With reference to FIG. 8, paper fiber is carried toward the discharge end 37b by internal flighting 46 as it is tumbled in the outer screen 38. As the paper fiber is being carried along toward the discharge 37b end of the outer screen 38, the fiber tumbles at the 7 o'clock position on the internal flighting 46. This positioning causes the inherent water in the slurry to drain through the slots and thereby thicken the slurry. The slurry enters the screen at approximately 1-2% consistency and discharges at approximately 3-6% consistency. The thickening caused by this water removal allows for greater storage efficiency of the paper slurry prior to downstream processing. Further, the water drained from the paper slurry carries with it unwanted material such as ash, small unusable fibers and ink particles. This removal feature enhances the overall cleanliness of the paper fibers and reduces the necessary equipment required downstream to remove ash and ink.

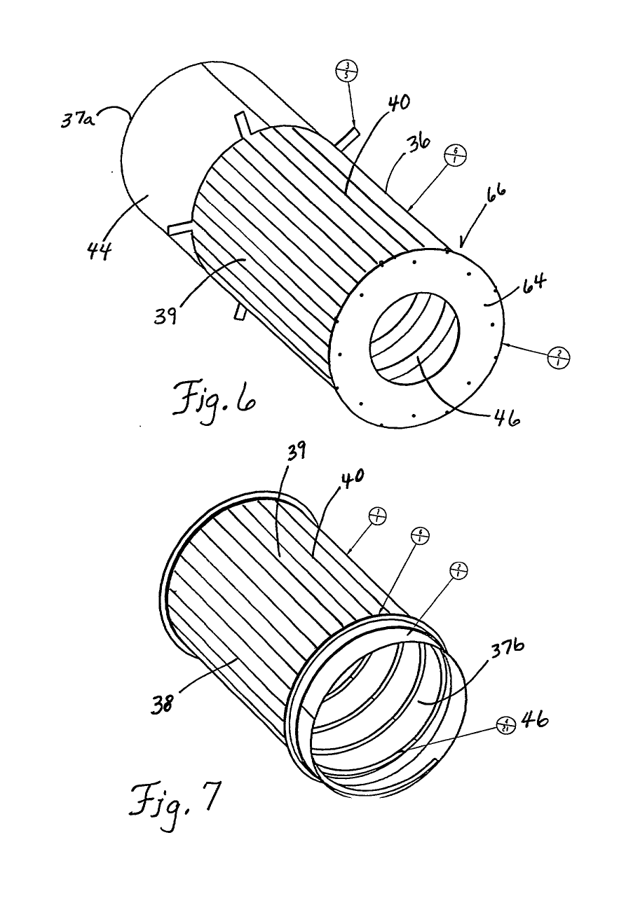

As stated previously, the double drum screen washer 34 further includes a discharge 37a for the inner screen 36 and a discharge 37b for the outer screen 38. The product captured by the inner screen 36 is discharged as rejects and the product captured by the outer screen 38 is discharged as accepts, therefore the product streams must be kept separated at the respective discharge points 37a, 37b. To this end, the inner drum screen 36 discharge point 37a is preferably extended preferably a predetermined distance beyond the outer drum screen 38 discharge end 37b. In the preferred embodiment, and as seen particularly in FIG. 6, the inner screen 36 is extended at least three (3) feet from the outer screen 38. The extended portion 44 is preferably formed from a solid plate (see also FIG. 6) having continuation of the internal flighting 46 to propel the material to the discharge 37a.

As the paper slurry is carried in the inner screen 36, and due to its natural tendency to dewater, it forms a mass 48 between the 6 and 8 o'clock positions as viewed from the discharge end 37a of the inner screen 36, as seen in FIG. 5. The mass 48 tumbles and dewaters, forming a dough-like elongated mass. Without additional dilution, this mass 48 is not able to pass through the slots 39 and into the outer screen 38. This is unacceptable since if the mass 48 is allowed to remain in the inner screen 36, the elongated mass will ultimately be discharged with the reject stream at 37a rather than separated. To ameliorate this situation it is preferable to provide the inner screen 36 with internal shower manifold(s) 50 and conventional nozzles 52. The shower manifold(s) 50 are of a size calculated to furnish the proper quantity of fluid to drive the nozzles 52. The fluid supplied by the shower manifold(s) 50 aids in dispersing the mass 48, dilutes the material and drives the paper fibers through the inner screen 36 slots 39.

The shower manifold 50 is preferably fitted with two banks of nozzles 52, although it is conceivable that other nozzle configurations may be used. An upper bank 54a of nozzles 52 spaced at predetermined intervals provides a cone shaped fluid stream, which is directed onto the fiber mass 48. The action of the fluid spray serves to disperse the mass 48. A lower bank 54b of nozzles 52 spaced at predetermined intervals, which are offset to those of the upper bank 54a, sprays a fan-shaped fluid stream onto the dispersed fiber mat. The action of fluid from the lower nozzle bank 54b dilutes the fiber mat sufficiently to allow the paper fibers to pass through the inner screen 36 slots 39 and into the outer screen 38. The process of dispersing the mass 48 by the upper nozzle bank 54a and dilution of the fiber mat by the lower nozzle bank 54b is repeated throughout the length of the inner screen 36. This ensures that the all paper fibers pass through the inner screen 36 and into the outer screen 38.

The shower manifold 50 is further preferably fitted with a series of guide blocks or wheels 56 with a cylindrical cleaner screen tube, or basket 58 placed over the manifold 50. As seen particularly in FIG. 8, the cleaner screen tube 58 is fitted with ultra high molecular weight endplates 61 (see FIG. 8) to keep the cleaner tube 58 in position around the manifold 50. At the discharge end 37a of the inner screen 36, the manifold 50 and cleaner tube 58 extend out and are supported by a frame assembly (not seen in this view).

Each cleaner tube 58 is fitted with a ring gear 62 that is turned by a motorized drive (not shown) to turn the entire cleaner tube 58 around the manifold 50. This action serves to clean collected debris and fiber from the manifold 50, as the manifold nozzles 52 clean the tube 58 during rotation.

In an alternative embodiment (not shown in these views), and for larger production systems, the double drum screen washer 34 may have a longer length. A double screen drum washer 34 having a long length may need further support at both ends of the washer 34. To accomplish this, a solid endplate 64, as seen in FIG. 8 on the infeed end 66 of the screen(s) 36, 38 is preferably incorporated to cover the gap (not shown) between the inner screen 36 feed opening and the outer screen 38. This alternative arrangement allows containment of the slurry in the screens 36, 38 while allowing the shower manifolds 50 to protrude from the frame endplate 64 for support.

The manifold frame assembly 68 is preferably adjustable to allow the manifold 50 to move vertically and horizontally to achieve ideal angle and distance from the inner screen 36 to thereby assist the fiber in passing through the inner screen slots 39.

Due to the nature of the slurry material and its roll position in the inner screen 36, only a fraction of the cylindrical screening surface area is actually utilized. To make use of more of the cylindrical surface area, lifting arms 70 (see FIG. 5) are preferably attached between the flighting 46. The lifting arms 70 scoop and carry a portion of the slurry material around the rotating inner screen 36 to a 4-6 o'clock position of the inner screen 36 as viewed from the discharge end 37a of the inner screen 36.

A second manifold assembly 50 is positioned in the 4-6 o'clock position with purpose to disperse and dilute the fiber through the inner screen 36. The lifting arms 70 thereby effectively double the amount of fiber discharged through the inner screen 36. The lifting arms 70 may be of any functional shape, however, as seen in FIG. 5, it is preferred that they be of a rolled or “V” shape. The lifting arms 70 are preferably mounted at adjustable angles relative the flighting 46 thereby allowing for quantity proportioning of material for each manifold 50. The lifting arms 70 further assist in the defibering process by leveling and thereby dispersing the fiber mass 48 or rolls.

The above-described embodiments of this invention are merely descriptive of its principles and are not to be limited. The scope of this invention instead shall be determined from the scope of the following claims, including their equivalents.

What is claimed is:

1. A method of recovering paper fiber from paper furnish material including the steps of:
providing an infeed belt-type conveyor for receiving furnish material;
providing a debaler for receiving and breaking up said furnish material;
providing a weighbelt conveyor including weigh cells and a timer mechanism for measuring and calculating weight flow of said furnish material;
providing a controller for controlling a predetermined water flow in ratio with a predetermined furnish weight flow;
providing a pulper arranged for receiving said predetermined furnish weight flow and said predetermined water flow, and including means for repeatedly lifting and dropping said furnish material in the presence of said water flow into a saturated fiber of predetermined consistency along with any remaining non-fibrous material;
providing a double drum screen washer including inner and outer rotating screens using wedge-wire design; and
providing at least one transfer conveyor.

2. A system for recovering paper fiber from paper furnish material including baling wires and other ferrous metals, said system comprising:
an infeed belt-type conveyor for receiving furnish material;
a debaler for receiving and breaking up said furnish material, and for severing said baling wires;
a dewirer arranged for removing said baling wires and said ferrous metals from said furnish material;
a weighbelt conveyor including weigh cells and a timer mechanism for measuring and calculating weight flow of said furnish material discharged from said dewirer over a predetermined time interval;
a controller for controlling a predetermined water flow in ratio with a predetermined furnish weight flow;
a pulper arranged for receiving said predetermined furnish weight flow and said predetermined water flow, and including means for repeatedly lifting and dropping said furnish material in the presence of said water flow into a saturated fiber of predetermined consistency along with any remaining non-fibrous material;
a double drum screen washer including inner and outer rotating screens using wedge-wire design; and
at least one transfer conveyor.

3. A system for recovering paper fiber from paper furnish material, said system comprising:
an infeed belt-type conveyor for receiving furnish material;
a debaler for receiving and breaking up said furnish material;
a weighbelt conveyor including weigh cells and a timer mechanism for measuring and calculating weight flow of said furnish material;
a controller for controlling a predetermined water flow in ratio with a predetermined furnish weight flow;
a pulper arranged for receiving said predetermined furnish weight flow and said predetermined water flow, and including means for repeatedly lifting and dropping said furnish material in the presence of said water flow into a saturated fiber of predetermined consistency along with any remaining non-fibrous material;
a double drum screen washer including inner and outer rotating screens using wedge-wire design; and
at least one transfer conveyor.

4. A system for recovering paper fiber from paper furnish material, said system comprising in sequence:
an infeed belt-type conveyor for receiving furnish material;
a debaler for receiving said furnish material from said infeed conveyor and breaking up said furnish material;
a transfer conveyor for transferring said furnish material from said debaler to a weighbelt conveyor, said weighbelt conveyor including weigh cells and a timer mechanism for measuring and calculating weight flow of said furnish material;
a controller for controlling a predetermined water flow in ratio with a predetermined furnish weight flow;
a pulper arranged for receiving said predetermined furnish weight flow and said predetermined water flow from said weighbelt, said pulper including means for repeatedly lifting and dropping said furnish material in the presence of said water flow into a saturated fiber of predetermined consistency; and
a double drum screen washer including inner and outer rotating screens wherein said inner and outer screens are of wedge-wire design.

5. In an apparatus for filtering particulate matter from water, the apparatus comprising:
a) a frame;
b) an outer drum rotatably mounted to the frame, the outer drum having portions defining generally cylindrical perforated screen which allows the passage of water therethrough but which retains particulate matter above a first size;
c) an inner drum mounted to rotate with respect to the frame and within the outer drum, the inner drum having portions defining a generally cylindrical perforated screen which allows the passage of water therethrough but which retains particulate matter of a second size, wherein the second size is greater than the first size;
d) means mounted on the interior or the outer drum for advancing particulate matter retained by the outer drum screen to an in inner drum discharge opening;
e) infeed means for supplying the particulate material and the water to the interior surface of the inner drum;
the improvement which comprises:
the addition of an imperforate extension to the length of said inner drum, said length being greater than the length of said outer drum.

6. In an apparatus for filtering particulate matter from water, the apparatus comprising:
a) a frame;
b) an outer drum rotatably mounted to the frame, the outer drum having portions defining generally cylindrical perforated screen which allows the passage of water therethrough but which retains particulate matter above a first size;
c) an inner drum mounted to rotate with respect to the frame and within the outer drum, the inner drum having portions defining a generally cylindrical perforated screen which allows the passage of water therethrough but which retains particulate matter of a second size, wherein the second size is greater than the first size;
d) means mounted on the interior or the outer drum for advancing particulate matter retained by the outer drum screen to an in inner drum discharge opening;
e) infeed means for supplying the particulate material and the water to the interior surface of the inner drum;
the improvement which comprises:
a shower manifold positioned within the interior of said inner drum, said manifold including at least one nozzle for distributing a predetermined amount of water for disbursing and diluting the mass of particulate matter through the perforations of said inner drum screen.

7. In an apparatus for filtering particulate matter from water, the apparatus comprising:
a) a frame;
b) an outer drum rotatably mounted to the frame, the outer drum having portions defining generally cylindrical perforated screen which allows the passage of water therethrough but which retains particulate matter above a first size;
c) an inner drum mounted to rotate with respect to the frame and within the outer drum, the inner drum having portions defining a generally cylindrical perforated screen which allows the passage of water therethrough but which retains particulate matter of a second size, wherein the second size is greater than the first size;
d) means mounted on the interior or the outer drum for advancing particulate matter retained by the outer drum screen to an in inner drum discharge opening;
e) infeed means for supplying the particulate material and the water to the interior surface of the inner drum;
the improvement which comprises:
a shower manifold positioned within the interior of said inner drum, said manifold including at least one nozzle for distributing a predetermined amount of water for disbursing and diluting the mass of particulate matter through the perforations of said inner drum screen, and adjusting means for positioning said manifold to obtain said predetermined amount of water.

8. In an apparatus for filtering particulate matter from water, the apparatus comprising:
a) a frame;
b) an outer drum rotatably mounted to the frame, the outer drum having portions defining generally cylindrical perforated screen which allows the passage of water therethrough but which retains particulate matter above a first size;
c) an inner drum mounted to rotate with respect to the frame and within the outer drum, the inner drum having portions defining a generally cylindrical perforated screen which allows the passage of water therethrough but which retains particulate matter of a second size, wherein the second size is greater than the first size;
d) means mounted on the interior or the outer drum for advancing particulate matter retained by the outer drum screen to an in inner drum discharge opening;
e) infeed means for supplying the particulate material and the water to the interior surface of the inner drum;
the improvement which comprises:
a shower manifold positioned within the interior of said inner drum, said manifold including at least one nozzle configured to distribute a fan-like spray of a predetermined amount of water and at least another nozzle configured to distribute a cone-like spray of a predetermined amount of water for disbursing and diluting the mass of particulate matter through the perforations of said inner drum screen.
